(19) United States
(12) Patent Application Publication
(10) Pub. No.: US 2010/0070257 A1
(43) Pub. Date: Mar. 18, 2010

(54) Methods, Systems, and Computer Program Products for Evaluating Electrical Circuits From Information Stored in Simulation Dump Files

(75) Inventors: Ajit Karthik Mylavarapu, Mountian View, CA (US); Sanjai Balakrishnan Athi, Santa Clara, CA (US)

Correspondence Address: TOWNSEND AND TOWNSEND AND CREW LLP/MIPS, TWO EMBARCADERO CENTER, 8TH FLOOR, SAN FRANCISCO, CA, 94111, US

(73) Assignee: MIPS Technologies, Inc., Mountain View, CA (US)

(21) Appl. No.: 12/210,150

(22) Filed: Sep. 12, 2008

(51) Int. Cl. G06F 17/50

(52) U.S. Cl. 703/16; 703/14

(57) ABSTRACT

Disclosed are methods, systems, and computer program products for evaluating performance aspects of electrical circuits, and particularly digital logic circuits. An exemplary method comprises obtaining access to a simulation dump file comprising state indications of the values of a plurality of signals of an electrical circuit at a plurality of simulation time points, and receiving an evaluation task that defines an output based on one or more input signals, with each input signal being a signal for which state indications are provided in the simulation dump file. The method further comprises generating, from the simulation dump file, one or more state representations for the input signals of the evaluation task, with each state representation being representative of the state of an input signal over a period of simulation time, and generating values of the output of the evaluation task at a plurality of simulation time points from the state representations.

### CROSS-REFERENCES TO RELATED APPLICATIONS

NOT APPLICABLE

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

The present invention relates to evaluating the operation of electrical circuits, such as digital logic circuits, microprocessors, and the like.

Current digital logic design typically involves the use of a Hardware Description Language (HDL) to construct an abstract representation of a logic circuit. The most used HDLs today are: Verilog, SystemVerilog, and Very High Speed Integrated Circuit Hardware Description Language (VHDL). Using an HDL, a designer can construct a register transfer level (RTL) description of the logic circuit at a high level of abstraction. The RTL description may then be used to construct a gate-level description of the logic circuit, which may be implemented in an integrated circuit. The RTL description may also be provided to a logic simulator to simulate the response of the logic circuit to any desired set of inputs. Such simulation is used to verify the design of the circuit before it is physically constructed.

The verification of the design of a logic circuit is lengthy and generally involves a number of simulation runs. Simulation runs are triggered by verification failures or design changes. Verification failures can be diagnosed in several ways. One common diagnostic technique is to configure the logic simulator to generate a data “dump” file that describes the state of several selected signals in the design at several time intervals preceding and including the failure point. As is well-known by those skilled in the art, the generally accepted standard data dump file for this is the “Value Change Dump” (VCD) format, defined in the IEEE Standard 1364-2001.

While VCD files are helpful in detecting functional faults in the electrical circuit, they are not particularly useful in helping the designer understand and optimize performance aspects of the circuit's design. For example, a designer might want to know how often a particular circuit section is active to determine if power-saving circuitry should be added to it. As another example, a designer of a microprocessor might want to understand how often cache misses are occurring in the design, or how effective branch-execution prediction circuits are. Evaluating and optimizing performance aspects of a logic circuit has historically involved adding extra test circuitry to the RTL description of the circuit, such as specialized detection logic and counters, rebuilding the logic circuit with the test circuitry included, re-running simulations, and extracting the desired information by viewing waveforms generated from the test circuitry. This approach increases the costs and complexity of designing the electrical circuit since it requires extra engineering time to design and verify the added test circuitry, and to remove the test circuitry before the circuit's design is implemented in physical form (e.g., before the synthesis stage). In addition, there is a risk that the test circuitry may not be completely removed, or that portions of the designed electrical circuit are accidentally removed, leading to an ill-functioning or non-function implementation of the electrical circuit.

What is needed is a way to enable designers to easily evaluate and optimize performance aspects of their circuit designs without the aforementioned added costs, complexities, risks, and design time.

### BRIEF SUMMARY OF THE INVENTION

In accordance with the present invention, output characteristics of a Value Change Dump (VCD) file from a logic simulation provide useful event information pertaining to one or more performance aspects of a simulated electrical circuit, and that the event information of the VCD file may be evaluated to generate information on the one or more performance aspects. For example, a designer can identify a number of signals of the design that pertain to a selected performance aspect, and can construct an evaluation task that generates information about the selected performance aspect from the identified circuit signals. An evaluation task may comprise one or more logic and/or mathematical expressions that generate one or more performance metrics (e.g., outputs) for the selected performance aspect from the signals saved in the VCD file. (An evaluation task may also mirror the action of the test circuitry that designers currently add to the RTL descriptions of their circuits.) The one or more logic and/or mathematical expressions may then be evaluated from the VCD file to generate the performance metrics and provided to the designer. Because the evaluation of the VCD file occurs after simulation, there is no need to incorporate test circuitry into the RTL description of the logic design, thereby avoiding the many problems of the prior art approach described above.

Accordingly, one general embodiment of the invention is directed to a method for evaluating an electrical circuit, the method broadly comprising defining an output based on one or more input signals for which state indications are provided in a simulation dump file over a period of simulation time, and generating values of the output of an evaluation task at a plurality of simulation time points from the state representations.

Another general embodiment of the invention is directed to a method for evaluating an electrical circuit, the method broadly comprising obtaining access to a simulation dump file comprising state indications of the values of a plurality of signals of an electrical circuit at a plurality of simulation time points, and receiving at least one evaluation task, where the evaluation task defines at least one output based on one or more input signals, with each input signal being a signal for which state indications are provided in the simulation dump file. The method further comprises generating, from the simulation dump file, one or more state representations for the one or more input signals of the at least one evaluation task, with each state representation being representative of the state of an input signal over a period of simulation time, and generating values of the one or more outputs of said at least one evaluation task at a plurality of simulation time points from the one or more state representations.

Another general embodiment of the invention is directed to a computer-readable storage medium configured to store instruction sets which, when executed by a processor of a computer system, become operational with the processor for evaluating an electrical circuit. The exemplary computer-readable storage medium broadly comprises a first instruction set for obtaining access to a simulation dump file comprising state indications of the values of a plurality of signals of an electrical circuit at a plurality of simulation time points, and a second instruction set for receiving at least one evaluation task, where the evaluation task defines at least one output based on one or more input signals, with each input signal being a signal for which state indications are provided in the simulation dump file. The exemplary computer-readable storage medium further comprises a third instruction set for generating, from the simulation dump file, one or more state representations for the one or more input signals of the at least one evaluation task, each state representation being representative of the state of an input signal over a period of simulation time, and a fourth instruction set for generating values of the one or more outputs of said at least one evaluation task at a plurality of simulation time points from the one or more state representations.

Another embodiment of the invention is directed to a system for evaluating an electrical circuit, the system broadly comprising a processor and a memory coupled to the processor, where the memory is configured to store a plurality of instruction sets which, when executed by the processor, become operational with the processor for evaluating an electrical circuit. The memory comprises a first instruction set for obtaining access to a simulation dump file comprising state indications of the values of a plurality of signals of an electrical circuit at a plurality of simulation time points, and a second instruction set for receiving at least one evaluation task, where the evaluation task defines at least one output based on one or more input signals, with each input signal being a signal for which state indications are provided in the simulation dump file. The memory further comprises a third instruction set for generating, from the simulation dump file, one or more state representations for the one or more input signals of the at least one evaluation task, each state representation being representative of the state of an input signal over a period of simulation time, and a fourth instruction set for generating values of the one or more outputs of said at least one evaluation task at a plurality of simulation time points from the one or more state representations.

The above general embodiments and other embodiments of the invention are described in the Detailed Description with reference to the Figures. In the Figures, like numerals may reference like elements and descriptions of some elements may not be repeated.

### BRIEF DESCRIPTION OF THE DRAWINGS

FIG. 1 shows an exemplary value-change dump (VCD) simulation dump file.

FIG. 2 shows a flow diagram of exemplary methods according to the present invention.

FIG. 3 shows an exemplary data structure that may be used to store representations of the data states of the input signals according to the present invention.

FIG. 4 shows an exemplary segment of pseudo-code that may be used to generate representations of the data states of the input signals according to the present invention.

FIG. 5 shows an exemplary data structure for storing the evaluation tasks according to the present invention.

FIG. 6 shows a parse tree for an exemplary Boolean expression.

FIG. 7 shows an exemplary data structure for representing the parse tree of the exemplary Boolean expression according to the present invention.

FIG. 8 shows an exemplary pseudo-code segment that may be used to parse the evaluation task statements according to the present invention.

FIG. 9 shows an exemplary pseudo-code segment that may be used to generate the outputs of evaluation tasks according to the present invention.

FIG. 10 shows an exemplary pseudo-code segment that may be used to output the results of the evaluation tasks to a VCD simulation dump file according to the present invention.

FIG. 11 shows an exemplary pseudo-code segment for a VCD file merge program invention that may be used to merge the input VCD file with an output VCD file having evaluation outputs according to the present invention.

FIG. 12 is a simplified block diagram of a computer system that may incorporate embodiments of the present inventions.

FIG. 13 shows a display output of a generic VCD viewer that shows the evaluation outputs of exemplary evaluation tasks along with the inputs from an input VCD file according to the present invention.

### DETAILED DESCRIPTION OF THE INVENTION

Invention Overview. The present invention enables a designer to define one or more evalution outputs to be generated by evaluating the information stored in a simulation dump file. An evaluation output may comprise a Boolean expression generated from one or more signal values in the dump file, and each output may be provided for plotting as a function of the simulation time points. An evaluation output may also comprise a running count of the number of defined clock cycles such a Boolean expression is True. To provide this functionality, an exemplary method according to the present invention may comprise receiving a description of the desired evaluation outputs, which may be referred to as a set of evaluation tasks, and then parsing the description to identify the inputs needed for the tasks and to generate an evaluation structure for each desired evaluation output. Using “SigA” and “SigB[3:0]” as names of exemplary input signals, an exemplary task may define an evaluation output “Out1” as a Boolean function of the input signals:

Out1=SigA AND (SigB[3:0]==“1111”). [1]

Another exemplary task may be to define a clock cycle for the simulation, a Boolean expression that is to be evaluated at the start of each defined clock cycle, and a count that is to be incremented each time the Boolean expression is true at a start of a defined clock cycle. The task may be defined with the following set of statements:

Set_Clock_Cycle(Start_time,Length); [2]

Out2[7:0]=Count(SigA AND (SigB[3:0]==“1111”),Optional_Reset_Condition). [3]

In the first statement, the start time of the first full clock cycle of the simulation, as measured in the simulation time, is provided by the value of “Start_time.” This value is typically zero. The length of each clock cycle, which is assumed to be constant, is provided by “Length,” which specifies the cycle length in the simulation time. The cycle Length is an integer value in the time scale of the VCD file. (For example, if the time scale of the VCD file is 10 ns, a 1 microsecond clock cycle would be represented by Length=100). The clock cycle typically follows a clock signal of the simulation, beginning at the rising edge of the clock signal. If one wishes to define the clock cycle at the falling edge of the clock signal, one may change the value of “Start_time” to coincide with the first falling edge of the clock signal in the simulation. The next statement defines an eight-bit signal Out2[7:0] and a count for the number of cycles that the Boolean expression SigA AND (SigB[3:0]==“1111”) is True. The statement may also provide an optional reset condition, which is a Boolean expression of signals that, when True, resets the count for Out2[7:0] to zero at the simulation time for which the expression becomes True. The statements of the evaluation tasks may be prepared by the circuit designer and saved in a text file.

Simulation Dump Files. VCD, defined in IEEE Standard 1364, the IEEE Standard for Verilog Hardware Description Language, is an ASCII-based format for simulation dump files output by EDA logic simulation tools. The VCD dumpfile provides detailed step-by-step results of a simulation run for analysis, re-simulation, or design verification. The VCD file comprises a header section with date, simulation software information including version number, and timescale information; a variable definition section containing scope information and lists of signals instantiated in a given scope; value changes for selected signals in a given scope; and time entries every time there is a state change of the selected signals. The VCD file is not explicitly divided into sections; rather, sections are identified by keywords that belong to each section. For example, keyword $timescale identifies a header section and defines the timescale of the simulation, key $end terminates a section, and keyword $var identifies a variable definition section to define the signals. Each signal defined in a variable definition section is assigned a shorthand identification code, which comprises a combination of one or more ASCII printable characters, such as “!” and “˜”. The shorthands are used in the value change section, instead of the full names of the signals, to reduce the size of the dump file, and to speed up the generation of the dumpfile by reducing I/O file writes.

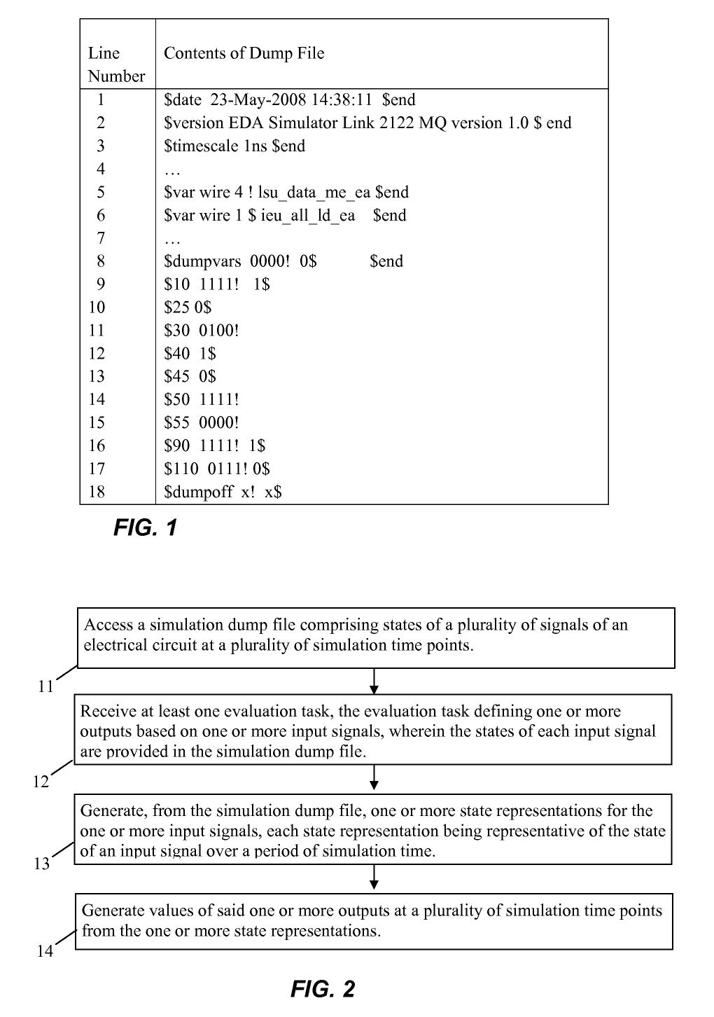

An exemplary VCD simulation dump file is shown in FIG. 1. It is for a circuit example that will be discussed later. Lines 1-3 of the dump file provide header information, such as indicating when the simulation was run and what logic simulator was used. Line 3 provides timescale information; in this case, the timescale indicates that the time points are given in units of nanoseconds. Lines 5-6 of the dump file specify which variables (i.e., circuit signals) appear in the dump file, their corresponding shorthand notations, and the format in which their values are printed. Line 5 specifies that signal “lsu_data_me_ea” is four bits wide, and is represented in the dump file by the shorthand notation “!”, and line 6 specifies that signal “ieu_all_ld_ea” is one bit wide and is represented by the shorthand notation “$”. In line 8, the “$dumpvars” keyword denotes the beginning of the dump, and provides the values of the signals at the beginning of the simulation. In this case, signal lsu_data_me_ea[3:0]=0000 (shorthand “!”) and signal lsu_all_ld_ea=0 (shorthand “$”) at the zero simulation time point. “$end” denotes the end of the “$dumpvars” flag. Lines 9-17 then list specific simulation time points with the initial symbol “$”, and then provide the shorthand names and values of the signals that have changed at that time point. So, for example, line 9 indicates that, at the 10 ns simulation time point, the value of signal lsu_data_me_ea[3:0] has changed to 1111, and that the value of signal lsu_all_ld_ea has changed to 1. If a value of a signal is unchanged at a particular simulation time point, then its shorthand name and value will not appear in the line. The keyword “$dumpoff” at line 18 indicates the end of the dump file, with the variables being given undefined values, as indicated by the “x” symbols.

Referring to FIG. 2, exemplary methods, systems, and computer-program products according to the present invention access a simulation dump file at block 11, receive one or more evaluation tasks defining one or more evaluation outputs at block 12, generate state representations of the input signals specified by the evaluation tasks at block 13, and generate the evaluation outputs at block 14. An evaluation structure may be constructed for each evaluation task. An evaluation structure may comprise a number of forms, and may include one or more data structures, one or more parse trees to evaluate Boolean expressions, and/or one or more segments of self-writing code (such as in an intrepreted computer language). From the received evaluation tasks, the input signals needed from the simulation dump may be identified, and a state representation for each of these input signals may be generated at block 13. Each state representation is representative of the state of a corresponding input signal over a period of simulation time, which generally includes a plurality of simulation points. The evaluation structures may then be applied to the state representations of the inputs to generate the evaluation outputs, at a plurality of simulation time points, which is shown at block 14. These aspects are described below in greater detail.

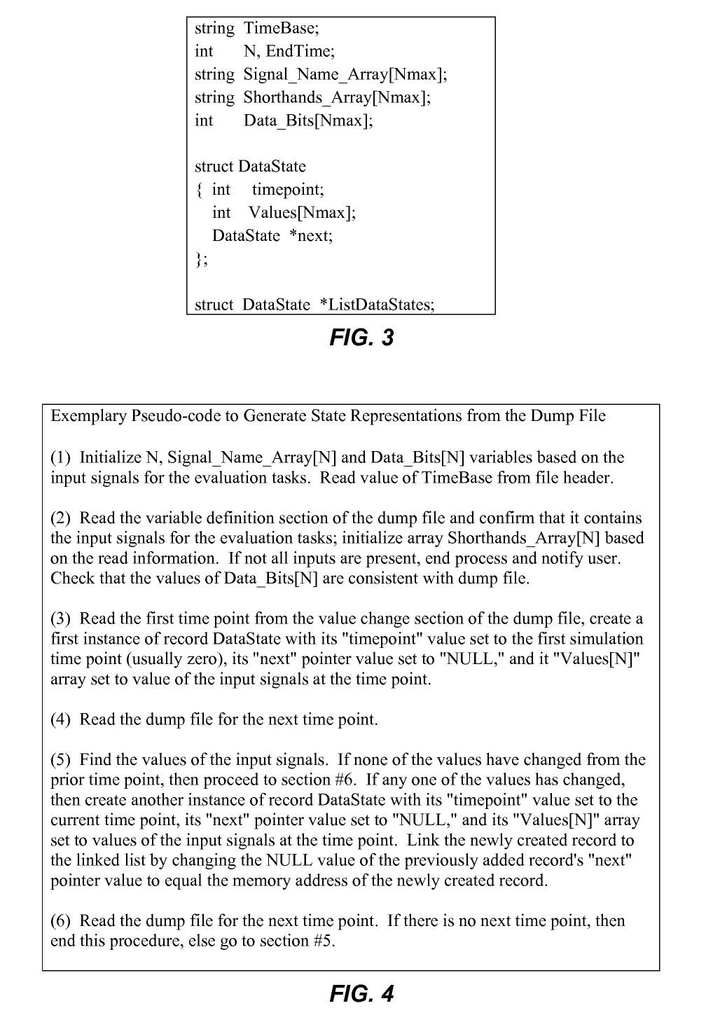

State Representation of the Input Signals. Generating state representations of the input signal may be as simple as reading the dump file for the values of the input signals at a given time point in the simulation, and then storing the values in a computer-readable memory. However, many aspects of the implementations of the methods, systems, and computer program products according to the present invention can be simplified by creating a data structure to represent the state values of the input signals at the simulation time points when any of the input signals changes state. For this, FIG. 3 shows an exemplary data structure that may be used to construct the state representations of up to Nmax number of input signals from the simulation dump file. The data structure is provided in pseudo C-language code, and one of ordinary skill in the programming arts will be able to translate the pseudo-code to full C-code or another language code without undue experimentation. A string TimeBase provides the timebase for the signals, as read from the simulation dump file. Next, an integer “N” is provided to indicate the actual number of input signals being used; it has a value equal to or less than Nmax, which is the maximum number of input signals that the data structure can handle. (More complex data structures may be used to remove this limitation.) A string array Signal_Name_Array[Nmax] holds the names of the input signals, and a string array Shorthands_Array[Nmax] holds shorthand names for the input signals, which will be extracted (e.g., parsed) from the simulation dump file. An integer array Data_Bits[Nmax] will hold an integer that indicates the number of bits in the input signal. For example, input signal SigA has one data bit, whereas signal SigB[3:0] has four data bits. The values of the input signals will be held in a linked list of records, each record having an integer “timepoint” to indicate the simulation time point for the record, an array “Values[Nmax]” to hold the signal values at the record's simulation time point, and a pointer to the next record. A record “struct” command defines the format of the record, which is called “DataState” in the pseudocode. The last statement in the pseudocode defines a variable “ListDataStates,” which will be a pointer to the start of the linked list of the data states. As data is read from the value change section of the simulation dump file, a first instance of DataState will be created at the first time point (which is usually time 0), the first instance will be filled with data at that time point, and ListDataStates will be updated to point to the memory address of the first instance.

Thereafter, as each additional time point is encounted, an additional instance of record DataState will be created and filled with data, and the previously created record instance will have its “next” value updated to point to the memory address of the newly added record instance. Each integer location in Values[Nmax] of the record structure DataState can hold up to 32 signal bits. If additional bits are needed, 64-bit or 128-bit integer definition may be used for Values[Nmax] in the struct definition. The values stored in Values[Nmax] correlate to the input signals named in Signal_Name_Array[Nmax]. That is, the value in Values[ii] is for the input signal named by Signal_Name_Array[ii], for any integer value of ii from 0 to (Nmax−1). The shorthands in Shorthands_Array[Nmax] correlate in a similar manner. When the “$dumpoff” keyword is encountered in the dumpfile, which indicates the end of the simulation time, an integer “EndTime” of the data structure of FIG. 3 is set to the last encountered simulation time point, plus a small number. The small number may be 1 or 2.

FIG. 4 illustrates a general outline of pseudo-code that may be used to fill the above-described data structure. One of ordinary skill in the programming arts will be able to translate the pseudo-code to C-code or another language code without undue experimentation. In section (1) of the pseudo-code, the evaluation tasks are examined to determine which input variables from the dump file are needed, and the values of N, Signal_Name_Array[N] and Data_Bits[N] are initialized. In section (1) of the pseudo-code, the header portion of the dump file is read for the timescale, and the read value is stored in string TimeBase. Also in section (1), the variable definition section of the dump file is read to confirm that it contains the input signals needed by the evaluation tasks. If not, the process is ended and the user is notified of the deficiency. The array Shorthands_Array[N] is initialized with the shorthand notations provided in the variable definition section of the dump file. The values of Data_Bits[N] are checked against the variable definitions of the dump file to ensure that they are consistent. If an inconsistency is found, the process is ended and the user is notified of the inconsistency.

In section (3) of the pseudo-code, the first time point from the value change section of the dump file is read, and a first instance of record DataState is created with its “timepoint” value set to the value of the first simulation time point (usually zero), its “next” pointer value set to “NULL,” and its “Values[N]” array set to values of the input signals at the time point. Conventional parsing code may be used to read the data from the value dump section according to the file's syntax, and the shorthands stored in Shorthands_Array[N] can be used to identify the values in the dump file. Section (4) of the pseudo-code reads the dump file for the next time point. Section (5) finds the values of the input signals. If none of the values have changed from the prior time point, then the pseudo-code proceeds to section (6). If any one of the values has changed, then another instance of record DataState is created with its “timepoint” value set to the current time point, its “next” pointer value set to “NULL,” and its “Values[N]” array set to values of the input signals at the time point. The newly-created record is then linked into the linked list pointed to by “ListDataStates” by changing the “next” pointer value of the previously added record to point to the memory address of the newly created record. Finally, in section (6) of the pseudo-code, the dump file is read for the next time point. If there is no next time point, then the process is ended and the value of EndTime is set to the last encounter simulation timepoint plus a small number; otherwise, the process goes back to section (5).

The above actions provide examples of implementing blocks 11 and 13 of FIG. 2. Other examples are possible.

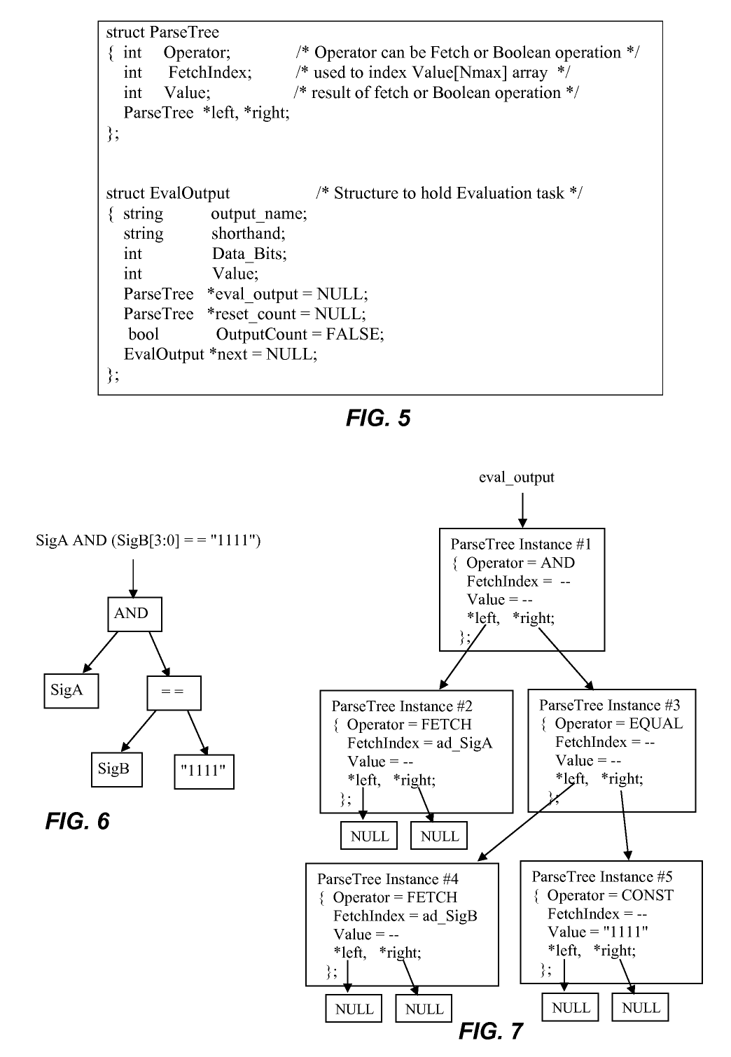

Parsing of Evaluation Tasks. Prior to generating the state representations of the input signals, the user's evaluation tasks are received, parsed, and embodied in data structures according to one embodiment. FIG. 5 shows an exemplary data structure, in pseudo-code form, that may be used. One of ordinary skill in the programming arts will be able to translate the pseudo-code to C-code or another language code without undue experimentation. A record structure “ParseTree” is defined to facilitate the parsing of Boolean expressions by a conventional-type recursive-descent parser and to enable their evaluation by a conventional-type recursive-descent evaluator. As explained below in greater detail, a collection of ParseTree records will be linked together in a tree structure to represent each Boolean expression of the evaluation tasks, such as the expression SigA AND (SigB[3:0]==“1111”) and the Optional_Reset_Condition of equation [3]. Also shown in FIG. 5 is a record structure called “EvalOutput”. An instance of EvalOutput will represent each evaluation task, such as provided by the above equations [1] and [3], except for the task Set_Clock_Cycle(Start_time, Length) of equation [2]. EvalOutput has a first string field “output_name” to store the user's name for the evaluation output, a second string field “shorthand” to store a program-generated short-hand name to enable the evaluation output to be written to a VCD file, a first integer “Data_Bits” to store the number of bits the user has assigned to the output, and a second integer “Value” to store the value of the evaluation output at the current simulation time. The record structure EvalOutput also has a field “eval_output” to store a pointer to a parse tree comprising a plurality of ParseTree records that represent the Boolean expression provided in the user's evaluation task, a field “reset_count” to store a pointer to a parse tree comprising a plurality of ParseTree records that represent an optional reset condition provided in the user's evaluation task, and a Boolean field “OutputCount” that specifies whether the record's “Value” field will store the value of Boolean expression or the cycle count of the Boolean expression. If OutputCount is set to True, then “Value” will store the cycle count of the Boolean expression at the current simulation time. If OutputCount is set to False, then “Value” will store the Boolean expression at the current simulation time. Finally, the record structure EvalOutput has a field “next” that holds a pointer to another instance of a EvalOutput record, thereby enabling a linked list to be created to store all of the evaluation tasks. As each Evaluation Statement is read and parsed, a corresponding instance of the EvalOutput record will be created and filled with data.

Before discussing the parsing of the Evaluation Statements, however, the parsing of Boolean expressions and the generation of corresponding parse trees is first discussed. FIG. 6 illustrates a simple parse tree for the Boolean expression “SigA AND (SigB[3:0]==“1111”)”, which may be generated by a conventional recursive descent parser or compiler. It comprises five nodes, as indicated by the five boxes. The first node represents the Boolean “AND” operation, which points to two children nodes “SigA” and “==”. The two children nodes represent two items that must first be evaluated before the AND operation can be performed. The left child node is simply SigA, which can be evaluated by fetching the current value of SigA, and does not require the evaluation of any children nodes below it in order to generate the value of SigA. Thus, the parse tree terminates at this node. The right child node of the “AND” node represents the quantity in parenthesis (SigB[3:0]==“1111”), which is an argument to the AND operation. This expression is generated from an equality (EQUAL) test operation (“==”) that requires signal SigB[3:0] and a constant “1111”. The equality node has two children nodes for these items. Both items can be generated without further evalution of children nodes, so the parse tree terminates at these nodes. A conventional-type recursive-descent parser can generate the nodes of the parse tree as it reads (e.g., parses) the Evaulation Statement provided by the user. A conventional-type recursive-descent evalulator can then use the parse tree for the expression to evalute the expression for any set of values for SigA and SigB. If a Boolean expression comprises the same logic operation among three signals or more signals, such as (SigA OR SigB OR SigC), the conventional recursive-descent parser will divide the expression into multiple logic operations, each of which operate on two quantities, such as (SigA OR (SigB OR SigC)).

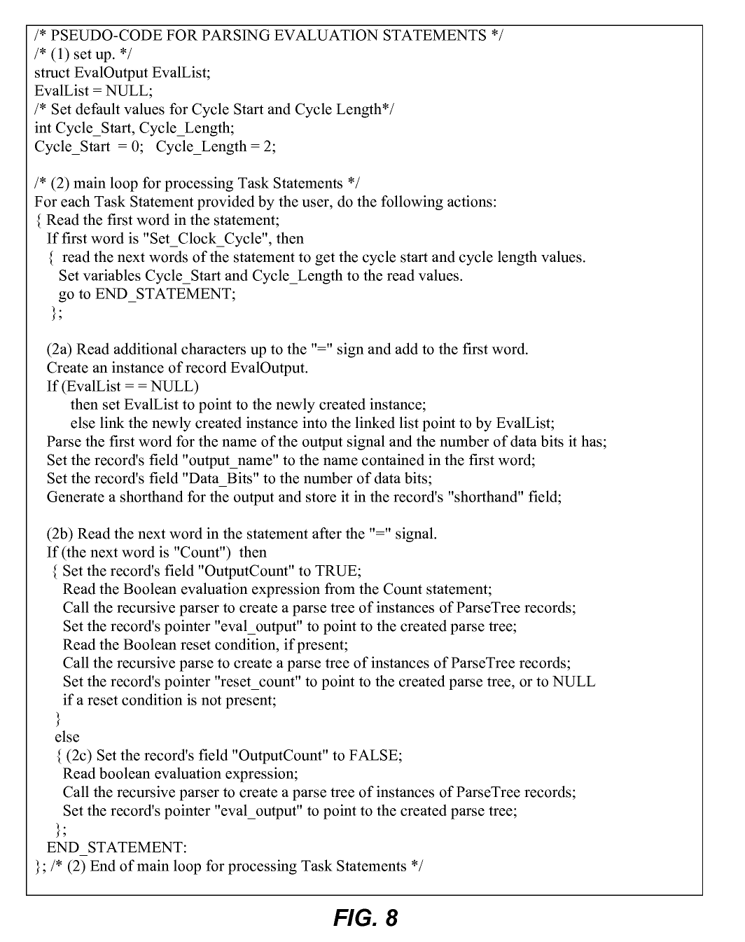

FIG. 7 illustrates how a set of five instances of the ParseTree record of FIG. 5 can be configured to represent the parse tree of FIG. 6, and to enable a conventional recursive descent evaluator to evaluate the expression SigA AND (SigB[3:0]==“1111”) for any value of the inputs SigA and SigB. Referring back to FIG. 3, the ParseTree record has an integer field to selectively represent a Boolean operation (such as EQUAL, NOT_EQUAL, LESS_THAN, GREATER_THAN, NOT, AND, OR, NAND, NOR, XOR, etc.), a fetch operation (FETCH), and a constant designation (CONST). This field will tell the evaluator how to interpret the node represented by an instance of ParseTree. In case the operation is a FETCH operation, record ParseTree has a field “FetchIndex” which tells the evaluator which location in an “Values[Nmax]” array of the DataState record for the current simulation time to use to fetch the signal indicated by the node. The ParseTree record also has an integer field “Value” to hold the value that results from the evaluation of the operation specified by the node, and further has two pointer fields “left” and “right” that point to instances of ParseTree records for two children nodes.

A conventional-type recursive descent parser can be readily modified to create a ParseTree instance each time it creates a tree node, fill in the field values of the ParseTree instance as it processes the node, and to link the nodes in the structure of the parse tree. The result of this is shown in FIG. 7. This can be done by one of ordinary skill in the computer arts in view of the disclosure, and without undue experimentation. ParseTree Instance #1 is created when the AND node is processed. Its operator field is set to indicate the AND operation, and its left and right pointers are set to point to an Instance #2 and an Instance #3 of ParseTree. Instance #2 represents the fetch operation for SigA. Its operator field is set to indicate the FETCH operation, and the FetchIndex is set to a value “ad_SigA” that points to SigA in the Values[Nmax] array. Both its “left” and “right” pointers are set to “NULL” since no children nodes need be evaluated. Instance #3 represents the EQUALS operation. Its operator field is set to indicate the EQUALS operation, and its left and right pointers are set to point to an Instance #4 and an Instance #5 of ParseTree. Instance #4 represents the fetch operation for SigB. Its operator field is set to indicate the FETCH operation, and the FetchIndex is set to a value “ad_SigB” that points to SigB in the Values[Nmax] array. Both its “left” and “right” pointers are set to “NULL” since no children nodes need to be evaluated. Instance #5 represents the constant “1111”, which is stored in its “Value” field. Both of its “left” and “right” pointers are set to “NULL” since no children nodes need to be evaluated. The “Value” fields of Instances #1-#4 are left unfilled, and will be filed by the recursive evaluator.

Once the recursive descent parser has generated the record structure shown in FIG. 7, a pointer to it may be stored in an “eval_output” field of an instance of record EvalOutput, the latter of which represents an Evaluation Task. A recursive-descent evaluator may then receive the pointer provided in the “eval_output” field, and trace the parse tree pointed to it to generate a value for the expression represented by the tree. The evaluator may have the following software call format:

Value=RecursiveEvaluate(node_pointer,Values_pointer);

where node_pointer is a pointer to a ParseTree record of the tree, where Values_pointer is a pointer to an array that has the values of the input signals, and where the function returns a value in integer form. Upon the initial call to the RecursiveEvaluate( ), node_pointer may be set to the eval_output pointer of an EvalOutput record, and Values_pointer may be set to Values[Nmax] array of a DataState record (shown in FIG. 3).

When the recursive evaluator is called to evaluate ParseTree Instance #1, it will return a value that is the Boolean AND of the values provided by its left and right children. Before it can compute the AND operation, however, it performs a function call of a second instance of itself (a recursive call) to obtain the value of the left child. After that, it performs a function call to a third instance of itself to obtain the value of the right child. These values may be stored in the “Value” fields of Parse Tree Instances #2 and #3, and they may be provided through return values from the function calls. The second and third instances may be called from the first instance as follows:

LeftVal=RecursiveEvaluate(left,Values_pointer);

RightVal=RecursiveEvaluate(right,Values_pointer);

With both of the right and left values obtained, the first instance of the recursive evaluator places the AND operation of the left and right values LeftVal and RightVal in the “Value” field of ParseTree Instance #1 and returns the result to the calling code. But before it can do that, the second and third instances of the evaluator must complete their tasks. The second instance of the evaluator does a simple Fetch operation to get the value of SigA. It stores this value in the “Value” field of ParseTree Instance #2 and provides this to the first instance of the evaluator as a return value LeftVal of the function call. The third instance of the recursive evaluator will return a Boolean value resulting from the EQUALS test applied to the values provided by its left and right children. Before it can compute the EQUALS operation, it first calls a fourth instance of itself to obtain the value of its left child. After that, it calls a fifth instance of itself to obtain the value of its right child. These values may be stored in the “Value” fields of Parse Tree Instances #4 and #5, and are provided through return values of the function calls. With both right and left values obtained, the third instance of the recursive evaluator places the result of the EQUALS test in the “Value” field of ParseTree Instance #3, and provides it to the first instance as a return value RightVal of the function call. The fourth instance of the evaluator does a simple Fetch operation to get the value of SigB[3:0]. It stores this value in the “Value” field of ParseTree Instance #4 and provides this to the third instance of the evaluator as a return value of the function call. The fifth instance of the evaluator does a simple Constant operation and returns the value stored in the “Value” field of ParseTree Instance #5.

Now that the details of parsing and evaluating the Boolean expressions present in the evaluation task statements have been discussed, the parsing of an entire evaluation task statement and the generation of a corresponding representation in an EvalOutput record are discussed next. FIG. 8 shows an exemplary pseudo-code segment that may be used to parse the task statements. One of ordinary skill in the programming arts will be able to translate the pseudo-code to full C-code or another language code without undue experimentation. In section (1) of the pseudo-code, a pointer EvalList is created to point to a linked list of EvalOutput records that will be created as the Evaluation Statements are processed. It is initially set to a NULL value. Also, integer variables Cycle_Start and Cycle_Length are allocated and set to initial default values. These variables will be used to store the values provided by a Set_Clock_Cycle(*) statement. In section (2) of the pseudo-code, a main loop is provided to parse and process each Evaluation Task Statement provided by the user. In the first part of the section, the first word of the statement is read to determine if it pertains to a Set_Clock_Cycle(*) statement. If it does, the pseudo-code reads the rest of the statement for the cycle start and cycle length values, and sets its variables Cycle_Start and Cycle_Length to the read values. It then goes to the end of the loop, as identified by the END_STATEMENT label, so it can process the next statement. The next sections handle the processing of Boolean evaluation and counter tasks. In the section (2a), additional characters are read up to the “=” sign of the statement to get the output signal name and any identification of the number of data bits. An instance of the record EvalOuput is created for the evaluation task. If the instance is the first one to be created, then the EvalList is updated to point to the newly created instance; otherwise, the previously created instance of the record EvalOutput is linked to the newly-created instance by updating its next field to point to the newly created instance. Using the parse information, the “output_name” and “Data_Bits” fields of the newly-created instance are filled in. In case the evaluation output is saved to a VCD file, a shorthand name may be created and stored in the record's “shorthand” field.

In the next code section, section (2b), the next word in the Evaluation Statement after the “=” sign is read. If the word is “Count”, then several additional actions in section (2b) are performed to process the Count statement. If not, the statement is a Boolean expression task, and is processed in section (2c) under the “else” branch of the test statement. In section (2b), the record's field “OutputCount” is set to True, and the Count statement is processed by reading Boolean evaluation expression from the Count statement, and then calling the recursive-descent parser to create a parse tree of ParseTree records to represent the expression. A pointer to the parse tree is then saved in the “eval_output” field of the newly created EvalOutput record. The Count statement is further read for an optional reset condition (Optional_Reset_Condition). If one is present, the Boolean expression for the reset condition is read and provided to the recursive-descent parser to create a parse tree of ParseTree records to represent the expression. A pointer to the parse tree is then saved in the “reset_count” field of the newly created EvalOutput record. Processing then goes to the end of the loop, as identified by the END_STATEMENT label, to process the next statement.

In section (2c), the Boolean expression task is processed by setting the record's field “OutputCount” to False, by reading Boolean evaluation expression from the Boolean task statement, and then calling the recursive-descent parser to create a parse tree of ParseTree records to represent the expression. A pointer to the parse tree is then saved in the “eval_output” field of the newly-created EvalOutput record. Processing then goes to the end of the loop, as identified by the END_STATEMENT label, to process the next statement.

The above actions provide an example of implementing block 12 of FIG. 2. Other examples are possible.

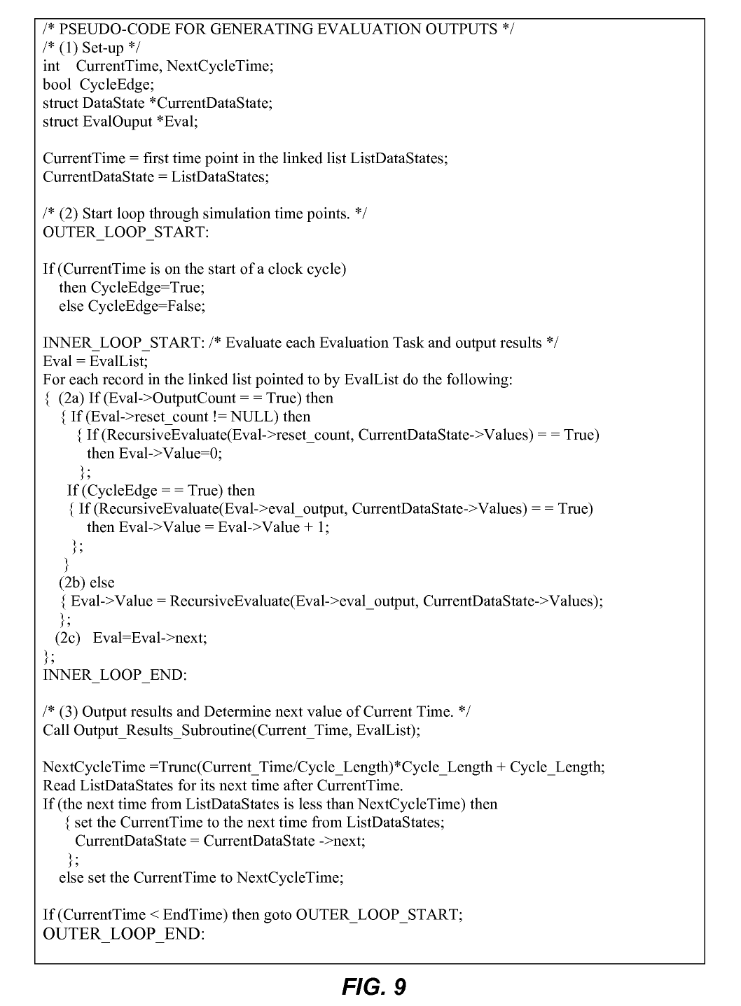

Generation of the Evaluation Outputs. FIG. 9 shows an exemplary pseudo-code segment that may be used to generate the evaluation outputs from the state representations of the input variables, such as provided by the linked list pointed to by “ListDataStates,” and the evaluation structure provided by the linked list pointed to by “EvalList”. One of ordinary skill in the programming arts will be able to translate the pseudo-code to full C-code or another language code without undue experimentation. The pseudo-code evaluates each of the evaluation tasks provided by “EvalList” at each simulation time point where there is a rising (or falling) edge of the clock, as defined by Cycle_Start and Cycle_Length, and each simulation time point in the linked list provided by “ListDataStates.” Boolean expression tasks will be evaluated at each of these points, but Count tasks will only be evaluated at the clock edges. Section (1) of the pseudo-code defines and initializes some variables that will be helpful in carrying out the above actions. Integer “CurrentTime” is a temporary variable that represents the current simulation time for the evaluations, and it is initialized to the first timepoint in the linked list provided by “ListDataStates.” An integer “NextCycleTime” will be used to compute the simulation time point of the next clock edge, and it will be compared against the next time in the linked list of ListDataStates as part of determining the next value of “CurrentTime”. A Boolean value “CycleEdge” will be computed each time “CurrentTime” is updated, and set to True if the clock edge is present at “CurrentTime”. The pseudo-code has an outer loop for stepping through the simulation time points, and is identified by the labels “OUTER_LOOP_START” and “OUTER_LOOP_END.” The pseudo-code has an inner loop for stepping through the evaluation tasks, and is identified by the labels “INNER_LOOP_START” and “INNER_LOOP_END.” In section (1), a temporary pointer “CurrentDataState” is allocated and set to follow the current data state of the input variables as they are sequenced in the outer loop. Also in section (1) a temporary pointer “Eval” is allocated and set to follow the evalutation task currently being processed by the inner loop.

The outer loop starts at section (2) of the pseudo-code. It begins by determining if the current simulation time is at the start of a clock cycle. If so, it sets CycleEdge to True, otherwise it sets CycleEdge to False. The determination of whether the current simulation time is at the start of a clock cycle can be done by performing an integer divide of the variable CurrentTime by the variable Cycle_Length, and comparing the reminder of the division to Cycle_Start. (The remainder of the integer division is commonly known as the “modulo” of the two division variables.) If the remainder is equal to Cycle_Start, then the current time is at a rising edge of the clock. If not, then the current time is not at a rising edge of the clock. Next, the inner loop is executed to generate the evaluation outputs from the values of the input signals at the current time. The inner loop will be described below in greater detail. After the inner loop, the execution of the pseudo-code proceeds to section (3), where the CurrentTime and the evaluation outputs are provided to an output subroutine, and the next value for the current time (CurrentTime) is computed. The output subroutine, called Output_Results_Subroutine(*), is described below. As for the next value of the current time, the start time of the next cycle from the current time first is computed. This may be done by performing an integer division of the current time by the cycle length, such as with the mathematic operators Trunc(Current_Time/Cycle_Length), then multiplying the result of the integer division by the Cycle_Length, which provides the cycle time just prior to the current time. One cycle length may then be added to this to get the NextCycleTime. As the next part of section (3), the link list of data states is read to find out the next simulation timepoint after the current time. This may be done by accessing CurrentDataState->next->timepoint. This next simulation time is compared to the value in NextCycleTime. If it is less than NextCycleTime, then the next value of CurrentTime is set to the next simulation time of the linked list of data states, and the CurrentDataState pointer is advanced to the next DataState record in the linked list of data states; otherwise, the next value of CurrentTime is set to NextCycleTime. The advancement of the CurrentDataState pointer may be done by the command “CurrentDataState=CurrentDataState->next;”.

The inner loop is now described. Temporary pointer Eval is set equal to EvalList, which is the start of the task list. Then Eval is stepped through each node of the EvalList linked list. The “OutputCount” field of Eval is tested to see if the evaluation task is a count task or a Boolean task. If it is a count task, section (2a) of the pseudo-code is executed. If it is a Boolean task, section (2b) of the pseudo-code is executed. In the Count processing, section (2a) first determines if a reset condition is specified by the count task. If one is present, it then calls the evaluator “RecursiveEvaluate” to evaluate the Boolean expression pointed to by “Eval->reset_count”. If the evaluation is true, then value of Eval is set to zero (Eval->Value=0); otherwise there is no change in the value. Next, it determines if the current time is at an edge of a cycle by testing to see if CycleEdge is True. If not, it proceeds to section (2c). If so, it calls the evaluator “RecursiveEvaluate” to evaluate the Boolean expression pointed to by “Eval->eval_output”. If the evaluation is True, then value of Eval is incremented by one. In the Boolean expression processing, section (2b) calls the evaluator “RecursiveEvaluate” to evaluate the Boolean expression pointed to by “Eval->eval_output”, and places the result in Eval->Value.

Both of sections (2a) and (2b) go to section (2c) for further processing. There, the Eval pointer is advanced to the next evaluation task in the list (“Eval=Eval->next;”).

The above actions provide an example of implementing block 14 of FIG. 2. Other examples are possible.

As another implementation approach, self-writing code may be used in place of the parse trees to evaluate the output and reset expressions of the evaluation tasks. In such an implementation, the pointers eval_output and reset_count of an EvalOutput record may comprise pointers to code functions, and these code functions may be written during each execution of the program by the pseudo-code shown in FIG. 8 for parsing the evaluation statements. Such self-writing code can be readily implemented in interpretive languages, such as the CH language. As yet another implementation approach, the inner loop in the pseudo-code shown in FIG. 9 for generating the evaluation outputs may comprises self-writing code that is generated by the pseudo-code shown in FIG. 8 for parsing the evaluation statements. In this implementation, the EvalOutput data structure may be simplified or converted to an array structure (rather than a linked list structure).

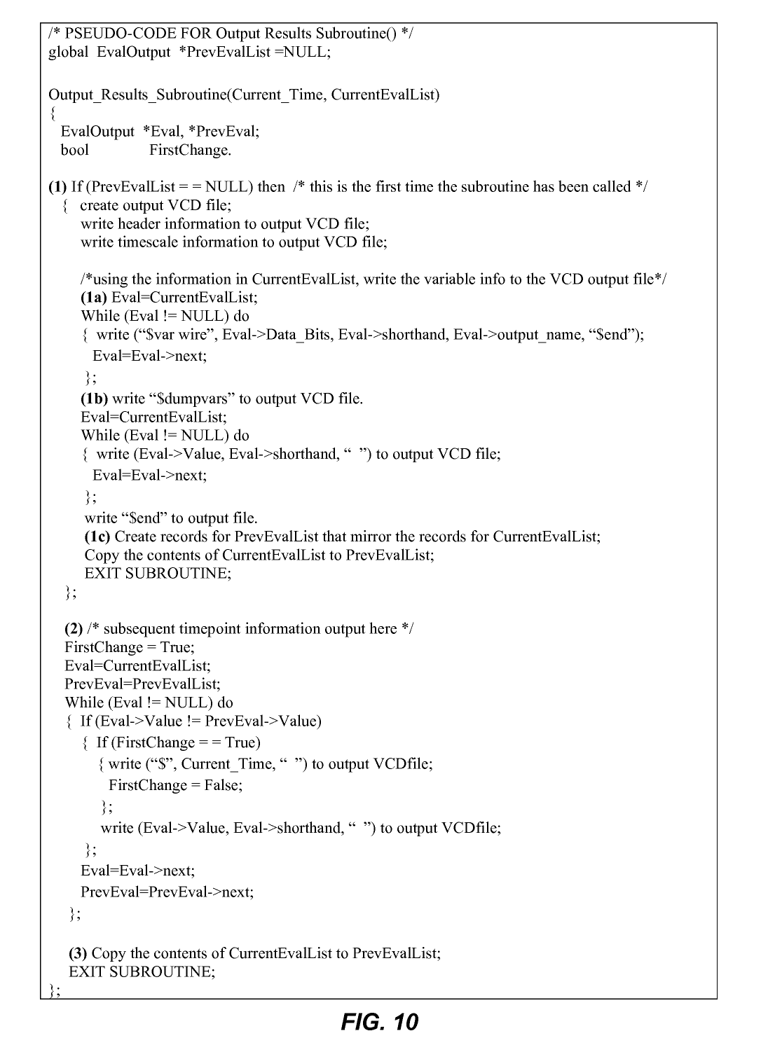

Output Subroutine. As indicated above, the Output_Results_Subroutine(*) is called in the outer loop to output the current time and the results of the evaluation outputs. The output subroutine can take many forms, depending upon the graphical user interface that is desired to provide the results. In the logic simulation art, there are several commercially-available graphical user interfaces generically called “VCD viewers.” In general, these products read in a VCD simulation dump file, present the user with a listing of the signals in the dump file, and allow the user to select a set of signals to be displaced. The VCD viewer also allows the user to advance through the time line of the simulations results. Accordingly, it would be advanteous to make use of existing VCD viewers, which may be done with an implementation of Output Results_Subroutine(*) shown in FIG. 10 that generates a VCD file of the evaluation outputs. A program called Merge_VCD_Files may then be used to merge the VCD file of the results with the original input VCD file, thereby enabling the user to correlate the results with all of the original signals of the simulation in a VCD viewer.

The exemplary implementation of Output_Results_Subroutine(*) is provided in pseudo C-language code in FIG. 10, and one of ordinary skill in the programming arts will be able to translate the pseudo-code to full C-code or another language without undue experimentation. The subroutine receives the current simulation time and a pointer to the EvalList at the current time (“CurrentEvalList”). A global pointer variable “PrevEvalList” is associated with the subroutine, and will be used by the subroutine to keep a copy of the last version of CurrentEvalList, which is the set of signals it previously processed. This will enable the subroutine to easily determine if there has been a change in the signals at the current time, in which case the subroutine will generate a new line in the VCD output file to output the changed states. The global pointer variable PrevEvalList is initialized to a NULL value before the subroutine is first called. The subroutine has a pointer variable “Eval” that will be used to step through the nodes of the CurrentEvalList linked list, and a pointer variable “PrevEval” that will step through the nodes of the PrevEvalList linked list.

At section (1) of the pseudo-code, the global pointer PrevEvalList is tested to see if it is equal to “NULL”, which would indicate that this is the first call of the subroutine, and that the beginning of the VCD output file needs to be created. If it is equal to NULL, section (1) of the pseudo-code creates the output VCD file (which may have a fixed file name), writes header information to the output VCD file, writes timescale information to the output VCD file, and writes the variable definition section. The latter action is done by the while loop at section (1b), where pointer Eval steps through the CurrentEvalList linked list, and where the Data_Bits value, shorthand name, and full name of each evaluation output signal are written. Next, at section (1b), the “$dumpvars” keyword is written, and the initial values and shorthands of the evaluation outputs are written to the VCD file by a while loop, which steps pointer Eval through the CurrentEvalList linked list. After that, the “$end” keyword is written to the output VCD file to complete the $dumpvars command. Next, at section (1c), the linked list of records for PrevEvalList is created, and PrevEvalList is set to point to the linked list. Then the contents of the link list pointed to by CurrentEvalList are copied to the new linked list pointed to by PrevEvalList. The creation of the linked list for PrevEvalList may be integrated into the while loop of section (1a), and the copying of contents of the linked lists may be integrated into the while loop of section (1b). At this point, the global pointer PrevEvalList no longer has a NULL value. After this, the pseudo-code exits the subroutine.

Upon the next call of the subroutine, section (1) of the pseudo-code is not executed since PrevEvalList is no longer NULL. Instead, section (2) is executed. This section compares the evaluation outputs at the current time, as provided by CurrentEvalList, against their previous values, as provided by PrevEvalList. If there is no change in any of the output values, then no action is taken. If there is a change, then the current time is written to the file, along with shorthand of each output that has changed, along with its new value. Section (2) has a while loop that steps Eval and PrevEval through the CurrentEvalList and PrevEvalList linked lists in tandem, and compares the current and previous values of each output. If there is a difference between the values, the current time is written to the VCD output file if it is the first difference encountered by the while loop, followed by the value and shorthand of the output. The first difference encountered by the while loop is tracked by the Boolean variable FirstChange, which is set to True before the while loop, and then set to False after the first encounter. The writing of the current time is only done when FirstChange is true.

After section (2) is executed, section (3) is executed. This section copies the contents of the CurrentEvalList linked list to the PrevEvalList linked list in preparation for the next call of the subroutine. After all of the information has been written to the VCD file, the main subroutine may call a subroutine to write the “$dumpoff” command to the file, and to close the file. The subroutine may be modified to further output the values of the input signals. One of ordinary skill in the art may do this further modification with undue experimentation.

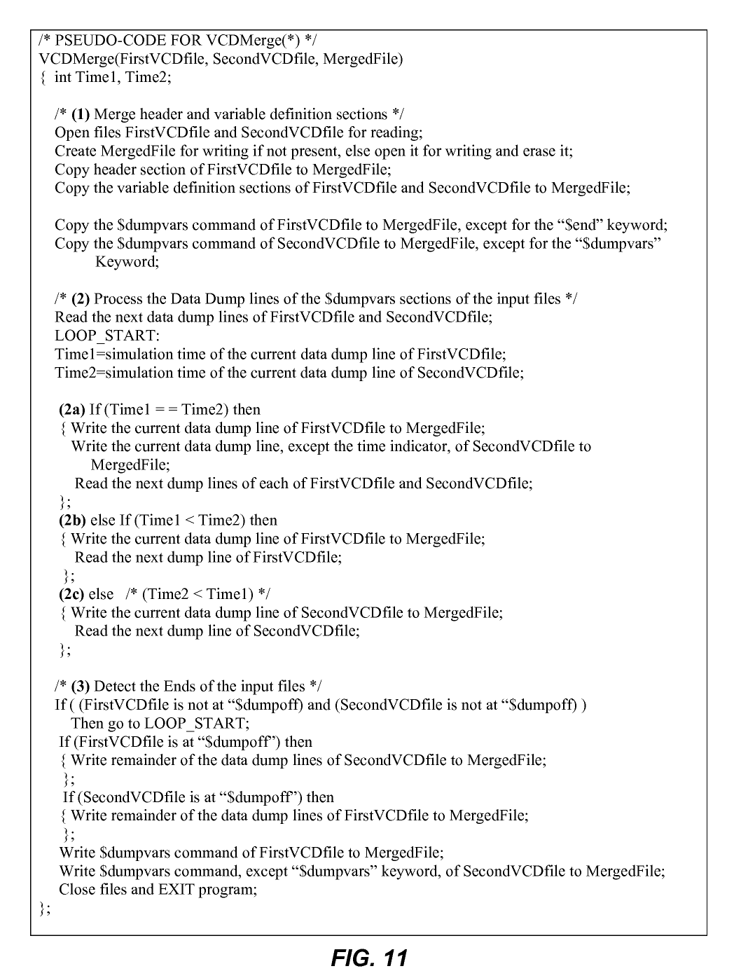

Merge VCD Files Program. Normally, there is no need to merge two VCD files. However, with the above inventions, it would be advantageous to have a facility that could merge the input simulation dump file with the output VCD file, thereby enabling a designer to view all of the signals of the simulation with the evaluation outputs in the output VCD file. FIG. 11 presents an exemplary program VCDMerge(*) that merges the contents of two VCD files into a merged file. The program is presented in pseudo C-language code, and one of ordinary skill in the programming arts will be able to translate the pseudo-code to full C-code or another language without undue experimentation. The program receives the names of two input VCD files, FirstVCDfile and SecondVCDfile, and the name of file to which the merged files are to be written, MergedFile. The pseudo-code has three general sections. In section (1), files FirstVCDfile and SecondVCDfile are opened for reading, and MergedFile is created for writing, if not present. If present, MergedFile, is opened for writing and erased. Next, the header section of FirstVCDfile is written to MergedFile, and the variable definition sections of FirstVCDfile and SecondVCDfile are written to MergedFile. Next, the $dumpvars command of FirstVCDfile is written to MergedFile, except for the “$end” keyword, and the $dumpvars command of SecondVCDfile is written to MergedFile, except for the “$dumpvars” keyword.

Section (2) starts by reading the first data dump lines of the input VCD files. It then starts a loop that steps through the data dump lines of the input VCD files and selectively writes the data dump lines to MergedFile based on the simulation times of the data dump lines. If the data dump lines of both input files have the same simulation time, then they are merged into one data dump line for MergedFile. If not, the data dump line of the file having the earlier simulation time is written to MergedFile. The start of the loop reads the simulation times of the current data dump lines into temporary integer variables Time1 (for FirstVCDfile) and Time2 (for SecondVCDfile). At section (2a), the two times are tested to see if they are equal. If they are, the data dump lines of both input files are merged and written to MergedFile, and the next lines of both input VCD files are read. If not, the pseudo-code progresses to section (2b), where the times Time1 and Time2 are tested to see if Time1 is less than Time2. If so, the current data dump line of FirstVCDfile is written to MergedFile, and the next data dump line of FirstVCDfile is read. If not, then Time2 is less than Time1, and the current data dump line of SecondVCDfile is written to MergedFile, and the next data dump line of SecondVCDfile is read. These tests are easily handled by a compound if-then-else statement, in which any order of the tests may be conducted.

Section (3) determines if the current line of either or both of the input VCD files is at the “$dumpoff” command. If both input VCD files are not at the “$dumpoff” command, then the execution of the pseudo-code returns back to the LOOP_START label of section (2) to do another iteration of the loop. If the FirstVCDfile is at the “$dumpoff” command, then the remainder of the data dump lines of SecondVCDfile are written to MergedFile. Otherwise, if the SecondVCDfile is at the “$dumpoff” command, then the remainder of the data dump lines of FirstVCDfile are written to MergedFile. At this point, all of the files may be closed, and the program exits operation. While the three tests of section (3) have been programmed into separate sections, it may be appreciated that they can be handled by a compound if-then-else statement, in which any order of the tests may be conducted.

The designer may then open MergedFile with a VCD viewer and view the evaluation outputs along with all of the simulation signals of the input VCD file. To provide a simple interface for the designer, a simple operating-system level script (e.g., a UNIX shell script) may be written to call the main program for generating the evaluation outputs, the VCDMerge(*) program, and the VCD viewer in successive order, and to manage the input, output, and merged VCD files.

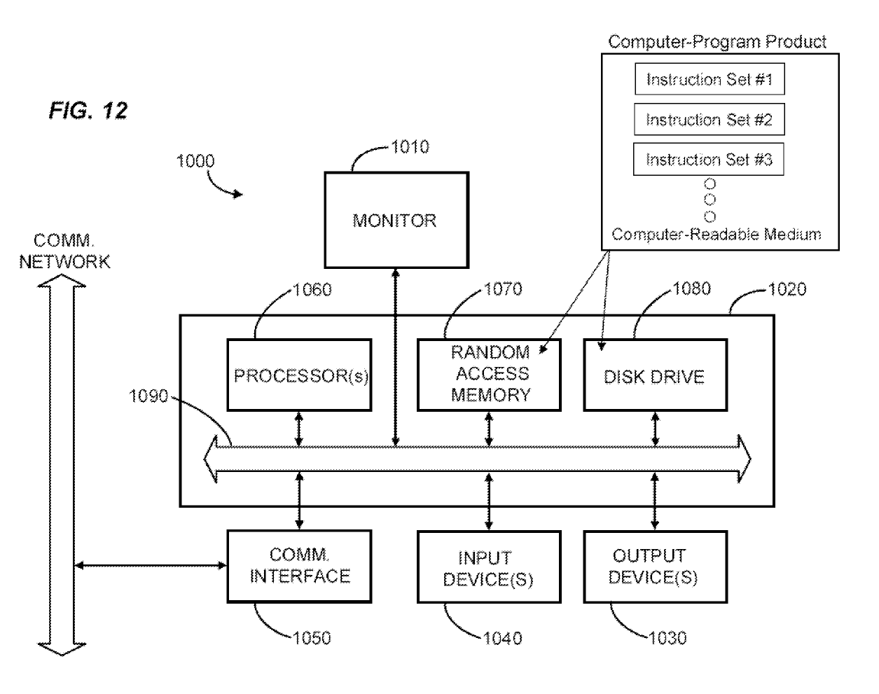

System and Computer-Program Product Embodiments. The above method and pseudo-code embodiments may be implemented by computer-program products that direct a computer system to perform the actions of the methods and pseudo-codes. Each such computer-program product may comprise sets of instructions embodied on a computer-readable medium that directs the processor of a computer system to perform corresponding actions, including the creation of various data structures and/or self-writing code. FIG. 12 shows a simplified block diagram of a computer system 1000 that may incorporate embodiments of the present invention. FIG. 12 is merely illustrative of an embodiment incorporating the present invention and does not limit the scope of the invention as recited in the claims. One of ordinary skill in the art would recognize other variations, modifications, and alternatives. In one embodiment, computer system 1000 typically includes a monitor 1010, a computer 1020, user output devices 1030, user input devices 1040, communications interface 1050, and the like.

As shown in FIG. 12, computer 1020 may include one or more processors 1060 that communicate with a number of peripheral devices via a bus subsystem 1090. These peripheral devices may include user output devices 1030, user input devices 1040, communications interface 1050, and a storage subsystem, such as random access memory (RAM) 1070 and disk drive 1080.

User input devices 1040 include all possible types of devices and mechanisms for inputting information to computer system 1020. These may include a keyboard, a keypad, a touch screen incorporated into the display, and other types of input devices. In various embodiments, user input devices 1040 are typically embodied as a computer mouse, a trackball, a track pad, a joystick, a wireless remote, a drawing tablet, and the like. User input devices 1040 typically allow a user to select objects, icons, text and the like that appear on the monitor 1010 via a command such as a click of a button or the like.

User output devices 1030 include all possible types of devices and mechanisms for outputting information from computer 1020. These may include a display (e.g., monitor 1010), non-visual displays such as audio output devices, etc.

Communications interface 1050 provides an interface to other communication networks and devices. Communications interface 1050 may serve as an interface for receiving data from and transmitting data to other systems. Embodiments of communications interface 1050 typically include an Ethernet card, a modem (telephone, satellite, cable, ISDN), (asynchronous) digital subscriber line (DSL) unit, FireWire interface, USB interface, and the like. For example, communications interface 1050 may be coupled to a computer network, to a FireWire bus, or the like. In other embodiments, communications interface 1050 may be physically integrated on the motherboard of computer 1020, and may be a software program, such as soft DSL, or the like.

In various embodiments, computer system 1000 may also include software that enables communications over a network such as the HTTP, TCP/IP, RTP/RTSP protocols, and the like. In alternative embodiments of the present invention, other communications software and transfer protocols may also be used, for example IPX, UDP or the like.

In some embodiments, computer 1020 includes one or more Xeon microprocessors from Intel as processor(s) 1060. Further, in one embodiment, computer 1020 includes a UNIX-based operating system, such as Linux.

RAM 1070 and disk drive 1080 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs and bar codes, semiconductor memories such as flash memories, read-only-memories (ROMs), battery-backed volatile memories, networked storage devices, and the like. RAM 1070 and disk drive 1080 may be configured to store the basic programming and data constructs that provide the functionality of various embodiments of the present invention.

Software code modules and instructions that provide the functionality of the present invention may be stored in RAM 1070 and disk drive 1080. These software modules and instructions may be executed by processor(s) 1060. RAM 1070 and disk drive 1080 may also provide a repository for storing data used in accordance with the present invention.

RAM 1070 and disk drive 1080 may include a number of memories including a main random access memory (RAM) for storage of instructions and data during program execution and a read-only memory (ROM) in which fixed instructions are stored. RAM 1070 and disk drive 1080 may include a file storage subsystem providing persistent (non-volatile) storage for program and data files. RAM 1070 and disk drive 1080 may also include removable storage systems, such as removable flash memory.

Bus subsystem 1090 provides a mechanism for letting the various components and subsystems of computer 1020 communicate with each other as intended. Although bus subsystem 1090 is shown schematically as a single bus, alternative embodiments of the bus subsystem may utilize multiple busses.

FIG. 12 is representative of a computer system capable of embodying the present invention. It will be readily apparent to one of ordinary skill in the art that many other hardware and software configurations are suitable for use with the present invention. For example, the computer may be a desktop, portable, rack-mounted or tablet configuration. Additionally, the computer may be a series of networked computers. Further, the use of other microprocessors is contemplated, such as Pentium™ or Itanium™ microprocessors; Opteron™ or AthlonXP™ microprocessors from Advanced Micro Devices, Inc; and the like. Further, other types of operating systems are contemplated, such as Windows®, WindowsXP®, WindowsNT®, or the like from Microsoft Corporation, Solaris from Sun Microsystems, LINUX, UNIX, and the like. In still other embodiments, the techniques described above may be implemented upon a chip or an auxiliary processing board.

Example Task—Evaluation of a Pipelined Load-Store Unit of a RISC Processor. This exemplary task is to find the number of cycles for which all four associative data cache ways of a load-store unit of a RISC processor are accessed by load operations during a particular section of a program segment. This information could, for example, be used to calculate the power consumption caused by the load operations as they propagate through a microprocessor pipe, and could be used by a designer to implement a variety of power saving techniques. In the circuit, there are four signals, denoted as “lsu_data_me_ea[3:0]”, for the four respective associative data cache ways, each of which is in an active high state when its respective cache way is active. Also in the circuit, there is a fifth signal, denoted as “lsu_all_ld_ea”, which is in an active high state when the load-store unit is using one or more of the associative data cache ways for load operations. Thus, an appropriate set of evaluation tasks could be:

All_Active=((lsu_data_me_ea[3:0]=‘1111’) AND lsu_all_ld_ea);

Set_Clock_Cycle(0, 1);

Cnt_All[7:0]=Count((lsu_data_me_ea[3:0]=‘1111’) AND lsu_all_ld_ea), 0);

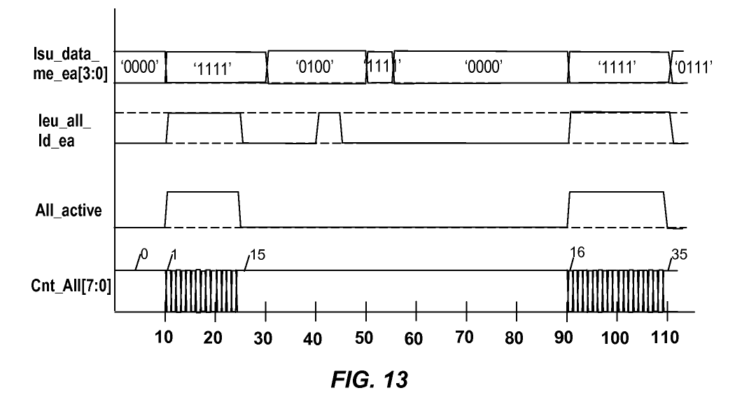

The first evaluation statement determines when all four data cache ways are active during loads, and the last two statements count the number of cycles in which the condition occurs, where the cycles start at timepoint 0 and each cycle is 1 timepoint in length. The input VCD file is provided by the file shown in FIG. 1. FIG. 13 plots the input signals and the evaluation outputs of All_Active and Cnt_All[7:0], as would be displayed by a conventional VCD viewer. As can be seen in the figure, lsu_data_me_ea[3:0] takes the value ‘1111’ during the following intervals: 10 ns-30 ns, 50 ns-55 ns, 90 ns-110 ns. Similarly ieu_all_ld_ea takes the value 1, during the following intervals: 10 ns-25 ns 40 ns-45 ns 90 ns-110 ns. Accordingly, All_Active is high during the ANDing of these intervals, which means it is high during the intervals of 10 ns-25 ns and 90 ns-110 ns. During the first of these intervals, Cnt_All[7:0] counts from 0 to 15. During the second interval, Cnt_All[7:0] counts from 15 to 35. Thus, during the 110 cycle simulation interval, all four cache ways have been active with load operations 35 of those cycles, or 31.8% of the cycles. This information can be used by the designer to determine what types of power-savings strategies to consider using for the load-store unit.

The specification and drawings are, accordingly, to be regarded in an illustrative rather than a restrictive sense. It will be evident that various modifications and changes may be made thereunto without departing from the broader spirit and scope of the inventions as set forth in the claims. In addition, the techniques, methods, computer-program products, and systems of the present invention are suitable for use with a wide variety of EDA tools and methodologies for checking, verifying, editing, revising, and fixing circuit layouts. The scope of the invention should, therefore, be determined not with reference to the above description, but instead should be determined with reference to the pending claims along with their full scope or equivalents.

1. A method for evaluating an electrical circuit comprising:
defining an output based on one or more input signals for which state indications are provided in a simulation dump file over a period of simulation time, and generating values of the output of an evaluation task at a plurality of simulation time points from the state representations.

2. The method of claim 1 wherein the output comprises at least one Boolean expression based upon at least two input signals.

3. The method of claim 1 wherein the at least one evaluation task comprises a count that is a function of at least one input signal.

4. A method for evaluating an electrical circuit, the method comprising:
accessing a simulation dump file comprising states of a plurality of signals of an electrical circuit at a plurality of simulation time points;
receiving at least one evaluation task, the evaluation task defining at least one output based on one or more input signals, wherein the states of each input signal are provided in the simulation dump file;
generating, from the simulation dump file, one or more state representations for the one or more input signals, each state representation being representative of the state of an input signal over a period of simulation time;
generating values of said at least one output at a plurality of simulation time points from the one or more state representations; and
storing the generated values of said at lease one output in a tangible computer readable memory.

5. The method of claim 4 wherein the at least one evaluation task comprises at least one expression based upon at least two input signals.

6. The method of claim 4 wherein the at least one evaluation task comprises at least one Boolean expression based upon at least two input signals.

7. The method of claim 4 wherein the at least one evaluation task comprises a count that is a function of at least one input signal.

8. The method of claim 5 wherein a second evaluation task defines a clock signal, and wherein the count is made with respect to the defined clock signal.

9. The method of claim 5 wherein the at least one evaluation task further comprises a count, and wherein the at least one output comprises a count of the number of times the at least one expression of the at least one evaluation task is True during cycles of a clock signal.

10. The method of claim 4 wherein storing the generated values comprises generating a value-change-dump file of the generated values.

11. A computer-readable storage medium configured to store instruction sets which, when executed by a processor of a computer system, become operational with the processor for evaluating an electrical circuit, the computer-readable storage medium comprising:
a first instruction set for accessing a simulation dump file comprising states of a plurality of signals of an electrical circuit at a plurality of simulation time points;
a second instruction set for receiving at least one evaluation task defining at least one output based on one or more input signals, wherein the states of each input signal are provided in the simulation dump file;
a third instruction set for generating, from the simulation dump file, one or more state representations for the one or more input signals, each state representation being representative of the state of an input signal over a period of simulation time; and
a fourth instruction set for generating values of said at least one output at a plurality of simulation time points from the one or more state representations.

12. The computer-readable storage medium of claim 11 further comprising a fifth instruction set for storing the generated values of said at lease one output in a tangible computer-readable memory.

13. The computer-readable storage medium of claim 12 wherein the fifth instruction set comprises instructions for generating an output value-change-dump file of the generated values, wherein the input simulation dump file comprises a value-change-dump file, and wherein the computer-readable storage medium further comprises a sixth set of instructions for merging the input value-change-dump file and the output value-change-dump file into a common value-change-dump file.

14. The computer-readable storage medium of claim 11 wherein the at least one evaluation task comprises at least one expression based upon at least two input signals.

15. The computer-readable storage medium of claim 11 wherein the at least one evaluation task comprises a count that is a function of at least one input signal, and wherein the fourth instruction set comprises instructions for generating the count.

16. The computer-readable storage medium of claim 15 wherein a second evaluation task defines a clock signal, wherein the count is made with respect to the defined clock signal, and wherein the fourth instruction set comprises instructions for counting the cycles of the clock for which the function has a specific value.

17. The computer-readable storage medium of claim 11, wherein the at least one evaluation task comprises a count that is a function of at least one input signal and a clock, the clock having cycles with a cycle length, and wherein the fourth instruction set comprises instructions for generating the count by evaluating the function at the start of each clock cycle.

18. The computer-readable storage medium of claim 17 wherein the third instruction set identifies a plurality of simulation time points in which at least one input signal changes states, and wherein the fourth instruction set further comprises instructions for advancing a time counter through the plurality of simulation time points and the cycles of the clock in sequential time order.

19. The computer-readable storage medium of claim 18 wherein the at least one evaluation task provides a reset condition for resetting the count, and wherein the fourth instruction set further comprises instructions for evaluating the reset condition at each value of the time counter, and for resetting the counter if the reset condition is True.

20. The computer-readable storage medium of claim 18 wherein a second evaluation task comprises a function of at least one input signal and a clock, and wherein the function of the second evaluation task is evaluated at each value of the time counter.

21-33. (canceled)
